(19) United States
(12) Patent Application Publication
(10) Pub. No.: US 2010/0323200 A1
(43) Pub. Date: Dec. 23, 2010

(54) Customisable Size Load Bearing Polymer Composite Frame

(75) Inventors: Andrew Beehag, New South Wales (AU); Rowan Johnson Paton, Victoria (AU); Michael Andrew Marelli, New South Wales (AU)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: CRC FOR ADVANCED COMPOSITE STRUCTURES LIMITED, Fishermens Bend, Victoria (AU)

(21) Appl. No.: 12/739,661

(22) PCT Filed: Oct. 24, 2008
(86) PCT No.: PCT/AU08/01585

§ 371 Date: Apr. 23, 2010

(30) Foreign Application Priority Data
Oct. 25, 2007 (AU) 2007905871

(51) Int. Cl. B32B 9/04; B29C 65/02; B32B 37/02; B32B 38/04; B32B 37/00

(52) U.S. Cl. 428/411.1; 156/64; 156/60; 156/256; 156/538

(57) ABSTRACT

An apparatus for welding together polymer composite components to form a composite frame, the apparatus including: a load bearing apparatus; a plurality of location elements for respectively locating at least one component of the composite frame to be assembled, each location element being connected to the load bearing apparatus; at least one of said location elements being a moveable location element, the position of said location element being moveable with respect to said load bearing apparatus; guides for the precise movement of said locating elements to position the composite components into a series of joints which form the composite frame; at lease one actuation means for the at least one moveable location element, the actuation means being attached to the load bearing apparatus and to the at least one moveable location element; at least one motion limiting apparatus applied to the at least one moveable location element, the motion limiting apparatus being either a means of control of the force applied by the at least one actuation means, or a mechanical stop. A method of fitting polymer composite components together to create a load bearing frame is also disclosed.

### FIELD OF THE INVENTION

The present invention relates to the joining together of polymer composite components to create a load bearing frame. In particular, the invention relates to joining thermosetting polymer composite components with thermoplastic surfaces in at least the joint area by interference fitting and subsequent welding, to form a load bearing frame. Adjustment of the frame dimensions can be easily made during the interference fitting operation, allowing a customisable frame size to be made with ease.

### BACKGROUND OF THE INVENTION

The manufacture of load bearing frames is commonplace in a wide range of industries, including automotive, civil infrastructure, and the manufacture of sporting goods. Traditionally these frames have been formed from metallic components. The ease of joining of these components by welding has seen their widespread application. Furthermore by cutting and shaping prior to welding, the load bearing frames have an inherent customisability. This flexibility of manufacture is also sought in the production of load bearing frames fashioned from composite materials.

The ability to manufacture custom size frames is important in the ability to make small adjustments. In practical manufacturing of frames it is necessary to accommodate for minor changes in dimension, and have some if not all of the elements capable of having small scale adjustment in their joint areas. Furthermore some designs will deliberately have variation in frame size, and with it may come a variation in the angle between joining elements. An example is the manufacture of a load bearing frame for a bicycle, which is ideally sized to suit the dimensions of the rider, and can have further adjustments for variations in performance and comfort. In both these instances and many other frame assembly scenarios, the ability to make adjustments in a non-permanent fashion, and subsequently fix the dimensions akin to a welding operation between metal elements, is a distinct advantage.

A significant portion of Load bearing frames is fashioned from composite materials in a rod or tubular form. It is possible to fashion a load bearing frame using a mould specially designed for the purpose, however this does not have the advantage of being easily adjustable in size. In abstract form, many of these elements can be considered as tube and connector elements, with the connector elements being fashioned as elbows or similar in order to transfer load between two tubes. These elements are connected by being in some fashion concentric in the joint area. Traditionally the connector element is sized so that the tube elements fit within it in the respective joint areas, and a means of fixing the elements together is applied.

Joining of conventional thermosetting composite elements cannot be achieved by welding, as the thermosetting resin does not melt with heat and resolidify on cooling. Furthermore, composite materials traditionally perform poorly when connected with mechanical fasteners, and in the assembly of load bearing frames these would render the composite construction highly inefficient. Instead, techniques for assembling composite load frames have been based on the use of an adhesive. This may be in the form of a liquid or paste, or alternatively in a film form. In order to obtain satisfactory performance in the joint area these adhesive layers must be thin, often between 100 and 500 microns in thickness. This provides a challenge for the use of adhesive in the joining of composite elements. Location of the elements to provide an even coating of liquid or paste adhesive is difficult, and if two of the elements are touching—i.e. have little or no adhesive between them—a failure of the joint may be initiated below the expected load. These issues are often overcome by the inclusion of a scrim in a film adhesive. However placement of a film adhesive in a joint area, followed by insertion of one composite element inside another, is a difficult and unreliable operation.

The present invention alleviates the aforementioned problems in constructing load bearing composite structures, by providing a method for the easy fitting together or assembly of composite components, followed by a fixing operation. Further, the method provides significant savings in labour to achieve an assembled composite frame, while increasing the performance and reliability in operation of these structures.

### SUMMARY OF THE INVENTION

Broadly, the present invention is a method for joining thermosetting polymer composite components together, where the mating surfaces of the components each have a thermoplastic surface in at least the joint area, and have at least some points of contact, sufficient to hold the components in their joined state for some time without additional restraint or tooling. The components are therefore brought together to form a load bearing frame structure, and subsequently the components are joined together more securely through the application of heat to the joint area. Where the assembled components have mating surfaces consisting of compatible thermoplastic polymers, they can be welded together to make a joint with high joint strength.

A first embodiment of the invention provides a method of fitting polymer composite components together to create a load bearing frame with dimensions customised at the time of assembly, including the steps of:
selecting thermosetting polymer composite components with thermoplastic polymer mating surfaces in at least the joint area that, when assembled and secured to each other, form a load-bearing frame;
sizing, the length of at least one of the composite components to provide a frame of desired size when assembled;
shaping, the thermoplastic surfaces in the joint area of said components to provide a neat or interference fit between the said components in their respective joint areas when inserted together;
pressing said components together in some way such that the mating surfaces of each component contact at points of contact in the joint area, resulting in at least local compressive stress in the thermoplastic surface at the point or points of contact, and relative immobility between the components:
optionally confirming the dimensional requirements of the assembled frame are in accordance with the customised dimensions;
raising the temperature of the joint area to a temperature where the thermoplastic material in the respective joint areas is able to flow and/or heal;
maintaining said temperature of the joint areas for a period to allow flow and/or healing and/or wetting; and
reducing the joint temperature in each joint, causing said thermoplastic material to solidify.

A second embodiment of the invention provides a method of fitting polymer composite components together to create a load bearing frame with dimensions and optionally angles between components customised at the time of assembly, including the steps of:
selecting thermosetting polymer composite components with thermoplastic polymer mating surfaces in at least the joint area that, when assembled and secured to each other, form a load-bearing frame;
selecting shaped elements for inclusion between the composite elements in the respective joint areas, such that a defined angle is achieved in assembly between said composite components, said shaped elements having a thermoplastic surface in at least the joint area that is compatible in welding with said composite components;
sizing, the length of at least one of the composite components to provide a frame of desired size when assembled;
shaping, the thermoplastic surfaces in the joint area of said components to provide a neat or interference fit between the said components and said shaped elements in their respective joint areas when inserted together;
pressing said components and said shaped elements together in some way such that the mating surfaces of each component contact with said shaped elements at points of contact in the joint area, resulting in at least local compressive stress in the thermoplastic surface at the point or points of contact, and relative immobility between the components:
   optionally confirming the dimensional requirements of the assembled frame are in accordance with the customised dimensions;
   raising the temperature of the joint area to a temperature where the thermoplastic material in the respective joint areas is able to flow and/or heal;
   maintaining said temperature of the joint areas for a period to allow flow and/or healing and/or wetting; and
   reducing the joint temperature in each joint, causing said thermoplastic material to solidify.

Preferably in the first or second embodiment of the invention, the thermoplastic mating surfaces on the composite components are made of similar or identical materials. In the second embodiment of the invention, the thermoplastic mating surface on the composite components is preferably of similar or identical material to the thermoplastic mating surface of the shaped elements.

Preferably the composite elements to be assembled are, respectively, long components and connector components. The long components may be in the form of a rod or tube, and may have a constant cross section. The connector components are preferably shaped to allow insertion of the long component within or around the connector component, in such a way as to form an enclosed joint area. More preferably in the first embodiment of the invention, the ends of the long components and connector components are shaped such that adjustments to the size of the load bearing frame can be made by cutting to size the long components, or changing the length of insertion between the long and connecting components, while maintaining at least some points of contact between the respective thermoplastic surfaces in the joint areas. More preferably in the second embodiment of the invention, the ends of the long components and connector components are shaped such that adjustments to the size of the load bearing frame can be made by cutting to size the long components, or changing the shape of the shaped element, or changing the length of insertion between the long and connecting components and shaped element, while maintaining at least some points of contact between the respective thermoplastic surfaces in the joint areas.

The shape of the joint area in the first and second embodiments of the invention may take many forms. Preferably, considering the movement in three principal axes of two composite components to be joined, there is sufficient contact in the respective joint areas to constrain relative movement between the assembled composite components to no more than two degrees of freedom: one translational and one rotational movement, which may be interdependent as in the insertion of a screw thread mating surface. These degrees of freedom allow the components to be fitted to each other, albeit under some required insertion force to overcome any friction between the components, while all other directions of movement are constrained.

Once the frame has been assembled, it is possible for the frame to be removed from the assembly apparatus to enable the dimensions to be confirmed or adjusted so that they are consistent with the customised dimensions. The frame may then be replaced on the assembly apparatus for the joints to be permanently set or the joints may be permanently set using other equipment.

The surfacing thermoplastic polymer may be amorphous or semi-crystalline, or have a limited amount of cross-linking such that flow is not impeded above the glass transition temperature or melt temperature of the polymer. The surfacing thermoplastic polymer may also contain a small amount of additional material, such as other polymers, fillers, discrete reinforcing fibres or a lightweight reinforcing fabric.

Preferably, where the composite component has a thermoplastic surface in the joint area, the surface thermoplastic is securely attached to the composite, by chemical or physical means. Physical means of attachment of a thermoplastic to a thermoset or thermoplastic composite may be on a macro scale through roughened surface interlocking or a similar process. More preferably, physical interlocking is created on a molecular level, through interlocking of the thermoset and thermoplastic polymer chains during cure of the thermoset composite component, or through interlocking of respective thermoplastic chains, where there is a discrete thermoplastic surfacing layer on a thermoplastic composite component. One method of providing a thermosetting polymer component with an interpenetrating thermoplastic polymer surface layer is the subject of International Patent Cooperation Treaty Application No. PCT/AU02/01014, the contents of which are incorporated herein by reference. Chemical means of attachment of a thermoplastic to a thermoset or thermoplastic composite may involve surface treatment of one or more of the components, prior to bringing the thermoplastic surface material in contact with the thermoset or thermoplastic composite.

The thermoplastic surface on the composite component in the first or second embodiment of the invention, and the thermoplastic surface of the shaped element in the second embodiment of the invention, may have parallel or tapered mating surfaces. Shaping the thermoplastic mating surface on a composite component in the first or second embodiment of the invention, where necessary, may be achieved by machining, or by melting and reshaping the surface with a tool. Advantageously, a composite component with a thermoplastic surface may have the thermoplastic surface reprofiled by means of a static or moving hot tool, shaped to provide the desired surface profile. A method of providing a reprofiled thermoplastic surface on a composite component is the subject of International Patent Cooperation Treaty Application PCT/AU2004/001272, the contents of which are incorporated herein by reference.

The thermoplastic surface on the composite components to be joined using either embodiment of the invention, and the thermoplastic surface of the shaped element in the second embodiment of the invention, may have continuous or discretely located thermoplastic on the mating surface. Additionally the thermoplastic surface or surfaces may be shaped so as to provide greater or lesser resistance to the insertion or fitting of the elements and/or components together, or to provide greater or lesser resistance to the separation of the elements and/or components once fitted together.

Cooling and heating applied to the shaped elements and/or components in either embodiment of the invention may be used in the invention during assembly. Advantageously, judicious use of cooling or heating of one or more components may assist in the generation of local compressive stresses in the joint following assembly.

The local stresses on the thermoplastic surfaces in the joint area may provide relative immobility between the composite components. Advantageously, this allows the frame to be moved between stages in the process of either the first or second embodiment of the invention, without unduly compromising the dimensional accuracy of the frame. More advantageously, minor adjustments to the dimensions of the frame, or the relative position of the composite components, can be simply made to the assembled frame.

The level of contact of the thermoplastic surfaces in the joint region may be made, preferably using a non-destructive inspection method. A preferred method for non-destructive inspection is the use of ultrasonics.

Enhancement of joint strength by heating of the joint regions, according to either the first or second embodiment of the invention, can be achieved between the shaped elements and/or composite components with a thermoplastic surface. Advantageously, where the insertion of shaped elements and/or composite components have the same thermoplastic mating surface securely attached, the invention provides a means to fix the assembled load bearing frame by welding, by the melting and later fusing together at least a portion of the contacting thermoplastic mating surfaces. Preferably, the thermoplastic surface material is selected such that heating the thermoplastic surface to cause flow can be achieved below the distortion temperature of any of the assembled components.

Heating may be provided external to the joint region by means of electric elements, or local provision of heated air or fluid. Alternatively ferromagnetic particles or electrically conductive material may be located in or near the joint region to provide heat for joining of the components.

Advantageously, where a neat or interference fit is obtained in the joint regions in either embodiment of the invention, a weld can be obtained between the components without application of compaction pressure in the region of the joint during welding.

Using the first embodiment of the invention, composite components with thermoplastic surfaces may be welded together. Preferably the thermoplastic surfaces consist of an identical thermoplastic. Advantageously, the surfacing thermoplastics may be dissimilar, and the selection of a thermoplastic-surfaced composite structure in the process of the invention includes the selection of a thermoplastic surface that is compatible in welding with a second thermoplastic on the surface of another component. Similarly, application of the second embodiment of the invention may involve the selection of thermoplastic surfaces on the composite components, and/or selection of a different thermoplastic on the surface of the shaped element, which is compatible with the other thermoplastic surfaces and/or components in welding. Preferably, in either embodiment of the invention, the thermoplastic surfaces will consist of an identical thermoplastic.

Where, according to either the first or second embodiment of the invention thermoplastic is located discretely on the at least one assembled component, the thermoplastic surfaces may be located and shaped so as to provide carefully-controlled local compression strain in the thermoplastic surfaces once fitted together, or optimum flow in the thermoplastic during the enhancement of joint strength by heating referred to above.

In any of the aspects or embodiments of the invention the thermosetting polymer or thermosetting composite component may include: bearings, bushes, shafts, inserts, foam or honeycomb or other core materials, other thermoplastic polymer subcomponents or films, or any other material that can be incorporated as an integral part of a largely thermosetting polymer or thermosetting polymer composite component, or thermoplastic polymer or thermoplastic polymer composite component.

Assembly of the shaped elements and/or composite components may be conducted with a variety of means. It is entirely feasible to assemble the elements by hand, where a low level of interference is desired in the joint area, or where the thermoplastic surfaces have been shaped to minimise insertion forces. Preferably in the second embodiment of the invention, the shaped elements are inserted at least partially onto or into a composite component, by manual or machine assisted means, prior to contact with the second adjacent component. In either embodiment of the invention, the ends of the shaped elements and/or composite components may be shaped to allow easy insertion, or guided assembly, or self-alignment during the assembly process.

Preferably, in either embodiment of the invention, an apparatus is used to assist in the assembly process, the apparatus including:
a load bearing apparatus;
a plurality of location elements for respectively locating at least one component to be assembled, each location element being connected to the load bearing apparatus;
at least one of said location elements being a moveable location element, the position of said location element being moveable with respect to said load bearing apparatus;
guides for the precise movement of said locating elements;
at least one actuation means for the at least one moveable location element, the actuation means being attached to the load bearing apparatus and to the at least one moveable location element;
at least one motion limiting apparatus applied to the at least one moveable location element, the motion limiting apparatus being either a means of control of the force applied by the at least one actuation means, or a mechanical stop.

The load bearing apparatus preferably comprises one or more plates or frames, to enable assembly of the composite components into a planar or three-dimensional composite load bearing frame.

Preferably, the at least one location element is shaped to securely hold the respective composite component without interference in the joint area, and apply sufficient force to the at least one composite component to fix its position relative to the location element without damage in subsequent operations.

Preferably the actuation means is selected from one of the following: a motor attached to a screw, gear or other mechanical apparatus for effecting relative motion; a linear motor; a hydraulic apparatus; a pneumatic apparatus. One or more actuation means may be used to move the moveable location elements during assembly. Preferably, where more than one actuation means is applied in a single plane, the movements of said actuation means act synchronously.

Preferably, the motion limiting apparatus is adjustable. Advantageously, this provides the operator of the apparatus with a means of adjusting the size of the resulting load bearing frame.

Optionally, the apparatus may also contain features to apply heat to the joint regions of the assembled frame, the means of applying heat to the frame being selected from one of the abovementioned heat application methods. Optionally, said features may also contain means to cool the joint region.

### BRIEF DESCRIPTION OF THE DRAWINGS

FIG. 1A is a sectional view of polymer composite tubes and connectors which may be joined to form a four-sided load bearing frame, each having a thermoplastic surface in the region to be joined, where the final dimensions of the load frame can be varied at the time of assembly;

FIG. 1B is a sectional view of the components depicted in FIG. 1A following assembly;

FIG. 2A is a sectional view of polymer composite tubes and connectors which may be joined to form a three-sided load bearing frame, each having a thermoplastic surface in the region to be joined, where the final dimensions and angles of the load frame can be varied at the time of assembly;

FIG. 2B is a sectional view of the components depicted in FIG. 2A following assembly of shaped elements to tube elements;

FIG. 2C is a sectional view of the components depicted in FIG. 2B following assembly;

FIG. 3 is a plan view of an apparatus for the assembly of an adjustable size polymer composite frame;

FIG. 4A is a sectional view of the components depicted in FIG. 1A held in the apparatus shown in FIG. 3, prior to assembly;

FIG. 4B is a sectional view of the components depicted in FIG. 1A held in the apparatus shown in FIG. 3 following assembly.

### DETAILED DESCRIPTION OF THE EMBODIMENTS

In the first embodiment of the invention, sufficient thermosetting composite components are assembled to make a load bearing frame. A preferred embodiment is the use of long components, such as tubes or rods, which make up the majority of the frame. These components can generally be manufactured simply, and often have simply defined loadings. Frequently the long component can also be resized where necessary, to provide for an adjustable frame size. The additional component type in said preferred embodiment is the connector component, which is required to transfer stress from one long component to another. This component will frequently have complex loading. It is a requirement for the first embodiment of the invention that each of the components to be joined also has a thermoplastic surface at least in the region to be joined. A preferred embodiment is the connection of composite tubular elements.

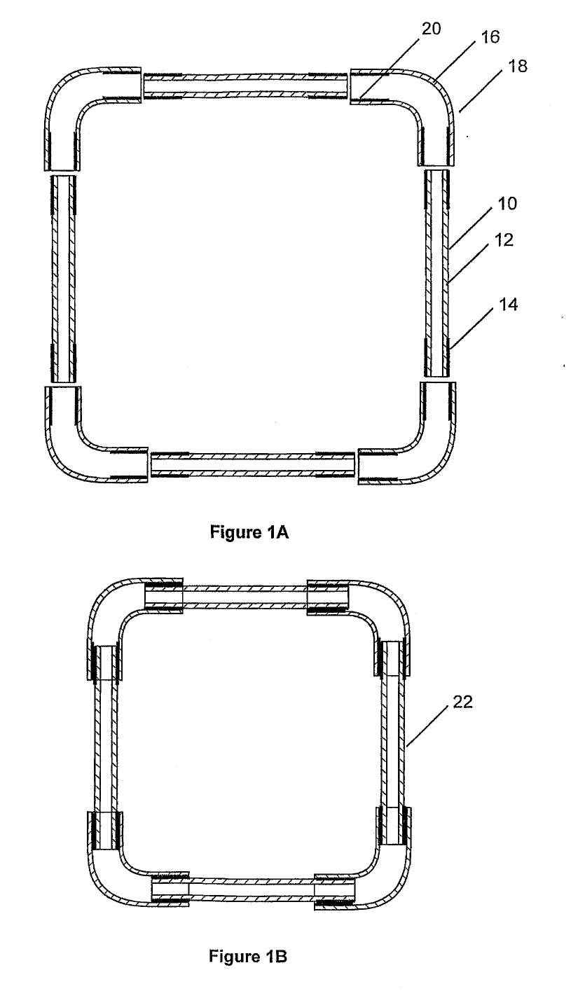

An example of a four-sided load frame is shown in FIG. 1A. There are four long tubular components 10 consisting of a thermosetting composite tube 12 having an outer thermoplastic surface 14 in the region to be joined. The tubes are shown to be constant in cross-section, however this is not a limitation of the invention, and tubes may vary in dimension across the length, and have any desired cross-sectional shape as determined by the loading requirements of the component or otherwise. Additionally there are connector components 16, consisting of a thermosetting composite connector shape 18 an inner thermoplastic surface 18 in the region to be joined. In the schematic shown in FIG. 1A the connector components 16 are tubular, but will frequently only be tubular in the region of the joint.

The choice of materials for the therinosetting composite tube 12 is very broad. Typically the tubes will consist of a continuous reinforcing fibre such as a glass or carbon fibre, held by a thermosetting resin such as an epoxy. However several other combinations of fibre, both material and form, as well as thermosetting resin are equally applicable to the invention. Surfacing of the composite tube 14 with a thermoplastic polymer 16 to obtain good strength in the joint region requires a high level of attachment between the tube 14 and thermoplastic 16. This can be achieved by a variety of means, including a number of surface treatments of the thermoplastic polymer to obtain adhesion to a thermosetting resin, the details of which are well detailed in public literature. However a high strength of attachment with high levels of durability is preferred in the invention, preferably achieving interpenetration of the thermosetting resin and thermoplastic polymer. This requires selection of a thermoplastic polymer that is compatible with the thermosetting resin, requiring careful selection of the constituents. A preferred method for material selection and manufacture of a thermosetting composite having a thermoplastic surface is detailed in PCT/AU02/01014.

For each region to be joined, the overall dimensions of the frame, and the precise dimensions of the joining region, need to be finalised prior to assembly. It is simplest in the example shown in FIG. 1A to alter the length of the long tubular elements 10. In order to provide a high strength joint, the dimensions of the outer thermoplastic surface 14 or inner thermoplastic surface 20 also need to be finalised for each joint region. A preferred method for shaping the thermoplastic in the joint region is detailed in PCT/AU2004/001272. It is preferred that there is an interference fit achieved between the joining elements in each of the joints, so as to provide sufficient compressive force for the subsequent welding stage. It may be preferable to have a thermoplastic surface 14 covering the entire length of the tube. Where this can be achieved without significant compromise in cost or function of the tube, this provides a means of having a highly adjustable component length, as the variation in length of the component is not limited by the need to maintain an intact joint region.

The example shown in FIG. 1A is a four-sided flat frame. It is feasible for the invention to apply to a minimum of two assembled components to an infinite number of assembled components, as long as the components when assembled form a load bearing frame. The invention is also not limited to assembly of components in two dimensions. It is perfectly feasible to have components joined to form multiple sub-frames with a single connector component, particularly with large constructions such as space frames, or constructions having multiple truss sections.

Assembly of the components is achieved applying force to slide the outer thermoplastic surface 14 of the tube component inside the inner thermoplastic surface 20 of the connector component. This may be done one joint at a time. However a practical load bearing frame will have a high level of stiffness in its components, necessitating that at least two of the joints are formed simultaneously. Most assembly will be achieved with the application of force such as hydraulic, pneumatic or mechanically derived force, in order to achieve the desired interference fit. A schematic of an assembled four-sided load bearing frame is shown in FIG. 1B. At this stage, the frame will have attained a high level of dimensional stability. The frame may be moved from its assembly rig without compromise. This is particularly useful for precise measurement of frame dimensions, which may be achieved with a template or purpose-built measuring device. Furthermore, minor adjustments to dimensions may be made at this time in a relatively simple manner. The frame may also be removed to allow determination of the contact quality of the thermoplastic surfaces. The use of a non-destructive inspection of the joint area, such as ultrasonic inspection, will provide an indication of the level of contact achieved between the thermoplastic surfaces. This can be productively used as an indicator of later joint quality, prior to the welding of the joint regions.

The assembled frame 22 has not achieved maximum strength until the thermoplastic surfaces 14, 20 of the assembled components are welded together, by raising the temperature of the thermoplastic surfaces 14, 20 to a point where flow of the thermoplastic occurs, and subsequent cooling of the thermoplastic to allow it to solidify. One option is to heat the entire assembly to achieve welding of the joints. Where selection of the thermosetting resin and thermoplastic polymer has been conducted such that the thermoplastic polymer is able to melt and flow below the glass transition temperature of the thermosetting resin, welding can be achieved without significant distortion of the components. The level of distortion will be primarily, in this instance, due to dimensional changes based on the coefficient of thermal expansion of the assembled elements. A preferred method is to localise the application of heat to the joint areas. This operation can be performed sequentially, or can be performed on all joint areas simultaneously. Application of heat can be achieved through a heated fluid, electrical resistance heating, or non-contact means such as the use of microwaves or induction energy. A preferred means of heating the joints locally is by contact heating of the outer composite component. Where selection of the thermosetting resin and thermoplastic polymer has been conducted such that the thermoplastic polymer is able to melt and flow below the glass transition temperature of the thermosetting resin, welding can be achieved without damage to or distortion of the joint region.

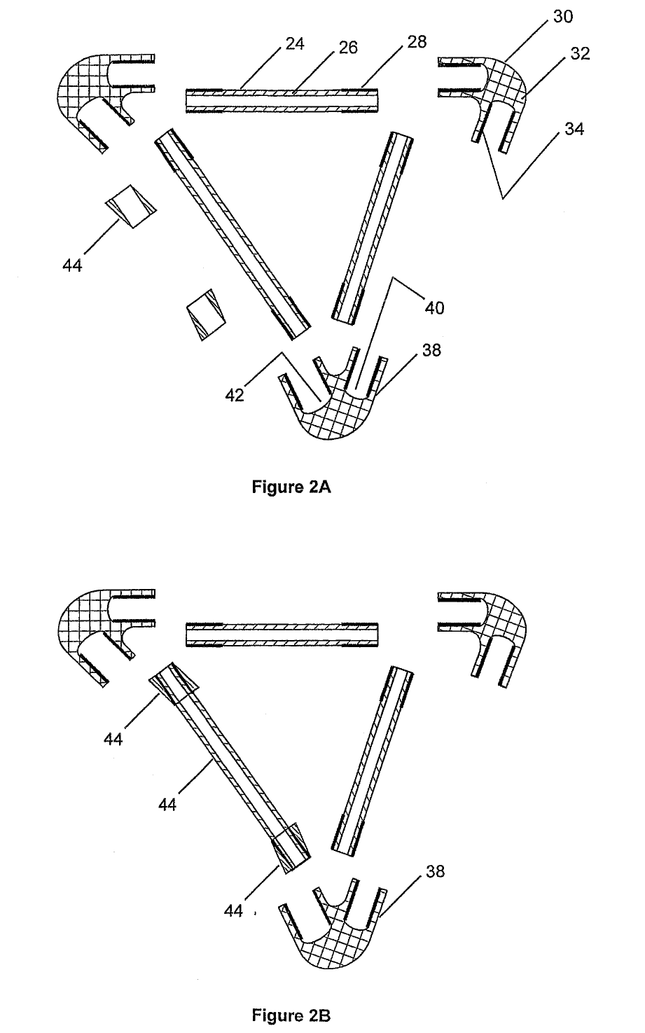

FIG. 2A shows components for a customisable size three-side composite frame, with elements for adjustable length and angle configuration. Tube components 24 are assembled with different lengths, each consisting of a thermosetting composite material 26 having a thermoplastic polymer surface 28 in at least the joint region. The desired size of the tubes can easily be adjusted to create a custom sized loading frame. Also shown are two types of connector, The first connector type 30 is typical in material selection of connectors, having a thermosetting composite 32 construction with thermoplastic surfaces 34 in the joint region. Additionally, the first connector type 30 has apertures 36 designed specifically for the desired angle of the tube components 24 i.e. there is no facility for angular adjustment. The second connector type 38 has one aperture 40 designed to hold a tube component 24 at a specific angle, and a second aperture 42 designed to hold a tube component 24 at a configurable angle to be determined, according to the second embodiment of the invention. In order to achieve the desired angle, shaped elements 44 are used to fill the space between the thermoplastic surface 28 of the tube component 24 and the thermoplastic surface 34 of the connector component 38. The shaped element 44 may consist entirely of a thermoplastic polymer, but it is not essential for the process of the invention. Preferably the shaped element 44 will have thermoplastic surfaces adjacent to the tube component 24 and connector component 38 in the joint region once assembled. More preferably the shaped element will have sufficient rigidity during a subsequent welding phase to provide controlled flow of thermoplastic during welding for optimal joint strength.

FIG. 2B shows assembly of the shaped element 44 onto a single tube element 24. The shaped element 44 may likewise be assembled inside the connector component 30, prior to assembly of the frame.

FIG. 2C shows assembled components and elements according to the second embodiment of the invention. The assembly of components and application of heat to the joint regions to weld the thermoplastic surfaces 28, 34 together with the shaped elements 44 is necessary to achieve maximum strength, using the preferred process already described for the previous example. By this means, a load bearing frame 46 with customisable geometry and angles is achievable.

It is a distinct advantage of both the first and second embodiments of the invention that assembly of the elements can be conducted over long periods of time without compromise to the structural performance of the resulting frame. When compared to assembly using adhesive systems, the thermoplastic surfaces may be stable in an assembled form, without welding, for an indefinite period of time. It is also an advantage that the assembly operation will not result in adhesive material being squeezed out of the joint region prior to obtaining maximum strength. This feature of adhesive systems is known to potentially compromise the strength of the assembled joint. Finally, where necessary, it is a distinct advantage to be able to disassemble the welded frames through the reapplication of heat to the joint regions. In this way, assembled components that do not meet the required standards can be replaced or re-welded in order to achieve the required standards.

Use of the second embodiment of the invention is likewise not restricted to the adjustment of component angles. Addition of thermoplastic film according to the second embodiment of the invention may be used to locally increase the amount of thermoplastic in the joint region. This feature is of particular use for disassembled frames, where the level of thermoplastic may be depleted in the joint region.

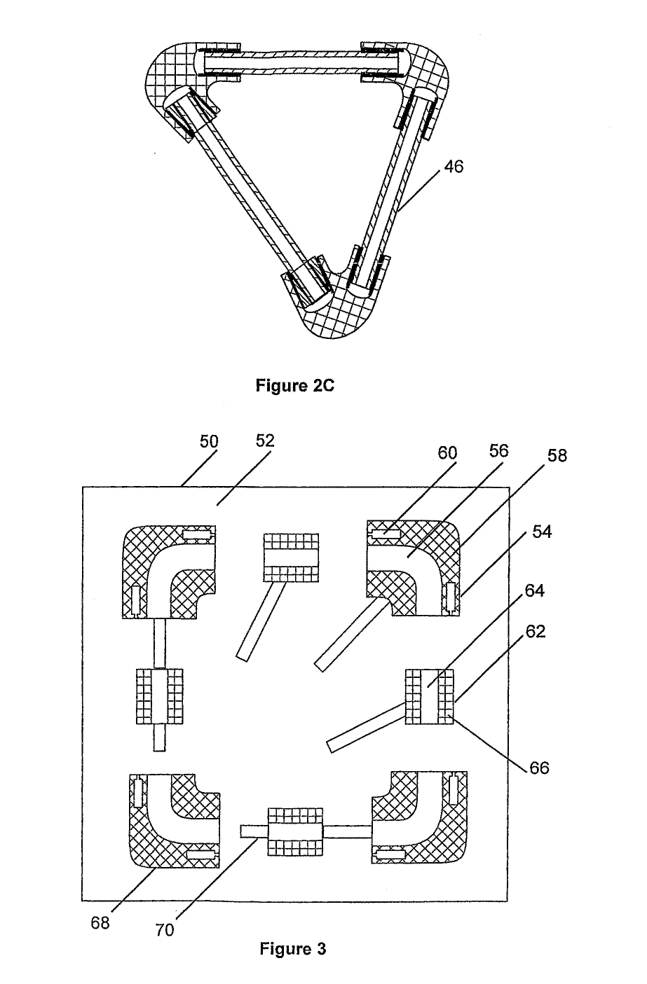

An apparatus 50 suitable for assembling a load bearing frame according to either embodiment of the invention is shown schematically in FIG. 3. The apparatus 50 has a plate 52 for locating the features of the apparatus. Location elements 54 suitable for holding connector components are attached to the plate 52. Each location element 54 features an aperture 56 suitable for tightly holding the connector element, and an element body 58 for applying force to the component. In an optional embodiment of the invention, the location element 54 can have embedded heating apparatus 60. Preferably the location element 54 is metallic, being suitable both for applying force and transferring heat to the connector element. Different location elements 62 are used to hold tubular components, each featuring an aperture 64 for locating the tubular component, and an element body 66 for applying force to the component. Generally these location elements 62 are also metallic, but are unlikely to have heating elements contained within them. In a preferred arrangement of the apparatus, one location element 68 will be fixed relative to the plate 52, while the other location elements 54, 62 will be able to move with respect to the plate 52. Guides 70 are located on or within the plate 52 to provide for accurate movement of the location elements 54, 62 with respect to the plate 52. Actuation means should also be provided to control the application of force to the moveable location elements 54, 62. The apparatus provided in FIG. 3 is exemplary of a simple, unified means of welding composite frames of varying dimensions, however is not the only means of providing such a frame. It is a distinct advantage of the invention that the assembled frame retains high dimensional stability prior to welding, and may be removed from one apparatus and placed in another. Two apparatus that separate the functions of assembly and welding may be equally considered, without compromise to the quality of the frame.

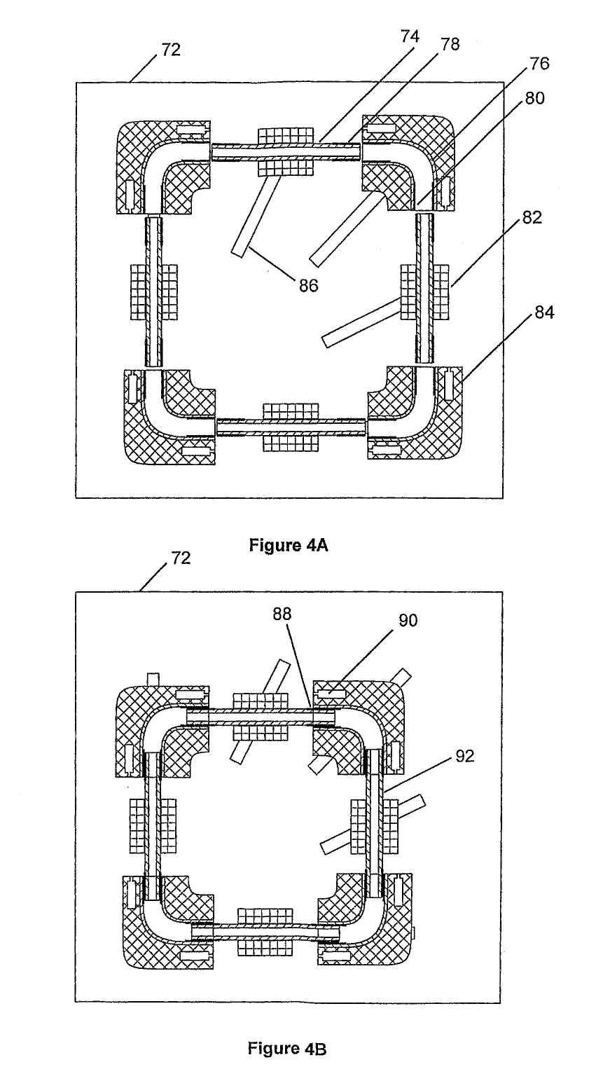

FIG. 4A shows the assembly of a four-sided load bearing frame using the apparatus 72 shown in FIG. 3. Prior to placing in the apparatus 72, tube elements 74 have their length established based on the required dimensions of the load bearing frame, and tube elements 74 and connector elements 76 have their thermoplastic joining surfaces 78, 80 shaped to provide a controlled interference fit upon assembly. Tube components 74 are fixed. in position with respect to location elements 82, while connector components 76 are fixed in position with respect to their respective location elements 84. In the apparatus 72 shown in this example, the guides 86 are established to provide for simultaneous assembly of all components 74, 76 in a single operation. Controlled actuation means are provided to the moveable location elements 82, 84, bringing the elements together until they have reached the desired load bearing frame dimension. In the apparatus shown in FIG. 4A, the actuation means may be one or more actuators with coordinated movement to provide for the simultaneous controlled translation of the location element 82, 84. The final location of the apparatus 72 and its location elements 82, 84 is shown in FIG. 4B. The apparatus 72 is capable of providing a range of frame sizes provided the guides 86 allow sufficient range of movement of the location elements 82, 84 and the actuation means has a method for providing a measured level of movement of the location elements 82, 84. Once the apparatus 72 has reached its final position, heat may be applied to the joint areas 88 by means of embedded heating apparatus 90. Upon cooling, the welded frame 92 can be removed from the apparatus 72.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of fitting polymer composite components together to create a load bearing frame with dimensions customised at the time of assembly, including the steps of:
selecting thermosetting polymer composite components with thermoplastic polymer mating surfaces in at least the joint area that, when assembled and secured to each other, form a load-bearing frame;
sizing, the length of at least one of the composite components to provide a frame of desired size when assembled;
shaping, the thermoplastic surfaces in the joint area of said components to provide a neat or interference fit between the said components in their respective joint areas when inserted together;
pressing said components together such that the mating surfaces of each component contact at points of contact in the joint area, resulting in at least local compressive stress in the thermoplastic surface at the point or points of contact, and relative immobility between the components:
optionally halting the process to allow checking of the dimension requirements of the assembled frame are in accordance with the required customised dimensions;
raising the temperature of the joint areas to a temperature where the thermoplastic material in the respective joint areas is able to flow and/or heal;
maintaining said temperature of the joint areas for a period to allow flow and/or healing and/or wetting; and
reducing the joint temperature in each joint, causing said thermoplastic material to solidify.

2. A method of fitting polymer composite components together to create a load bearing frame with dimensions and optionally angles between components customised at the time of assembly, including the steps of:
selecting thermosetting polymer composite components with thermoplastic polymer mating surfaces in at least the joint area that, when assembled and secured to each other, form a load-bearing frame;
selecting shaped elements for inclusion between the composite elements in the respective joint areas, such that a defined angle is achieved in assembly between said composite components, said shaped elements having a thermoplastic surface in at least the joint area that is compatible in welding with said composite components;
sizing, the length of at least one of the composite components to provide a frame of desired size when assembled;
shaping, the thermoplastic surfaces in the joint area of said components to provide a neat or interference fit between the said components and said shaped elements in their respective joint areas when inserted together;
optionally halting the process to allow checking of the dimensions of the assembled frame are in accordance with the required customised dimensions;
pressing said components and said shaped elements together such that the mating surfaces of each component contact with said shaped elements at points of contact in the joint area, resulting in at least local compressive stress in the thermoplastic surface at the point or points of contact, and relative immobility between the components:
raising the temperature of the joint area to a temperature where the thermoplastic material in the respective joint areas is able to flow and/or heal;
maintaining said temperature of the joint areas for a period to allow flow and/or healing and/or wetting; and
reducing the joint temperature in each joint, causing said thermoplastic material to solidify.

3. The method according to claim 1 or 2 wherein the thermoplastic mating surfaces on the composite components are made of similar or identical materials.

4. The method according to claim 2 wherein the thermoplastic mating surface on the composite components is an identical material to the thermoplastic mating surface of the shaped elements.

5. The method according to claim 1 or 2 wherein the composite elements to be assembled are long components and connector components, the long components being in the form of a rod or tube, the connector components being shaped to allow insertion of the long component within or around the connector component, in such a way as to form an enclosed joint area.

6. The method according to claim 1 or 2 wherein there is sufficient contact in the respective joint areas to constrain relative movement between the assembled composite components to one translational and one rotational degree of freedom, requiring insertion force to overcome any friction between the components, while all other directions of movement are constrained.

7. The method according to claim 1 or 2 wherein the surfacing thermoplastic polymer is amorphous or semi-crystalline, or has a limited amount of cross-linking such that flow is not impeded above the glass transition temperature or melt temperature of the polymer

8. The method according to claim 1 or 2 wherein the surfacing thermoplastic polymer contains a small amount of additional material, selected from the group consisting of other polymers, fillers or functional particles, discrete reinforcing fibres and a lightweight reinforcing fabric.

9. The method according to claim 1 or 2 wherein the thermoplastic surface of a composite component is attached to the underlying polymer composite by physical interlocking.

10. The method according to claim 1 or 2 wherein the thermoplastic surface on the first or second polymer composite component is attached through molecular level interpenetration of the surfacing thermoplastic and the underlying polymer.

11. The method according to claim 1 or 2 wherein shaping of the thermoplastic mating surface on a composite component is achieved by machining, or by melting and reshaping the surface with a tool.

12. The method according to claim 1 or 2 wherein the thermoplastic surface on the composite components to be joined is discretely located thermoplastic on the mating surface.

13. The method according to claim 1 or 2 wherein the thermoplastic surface material is selected such that heating the thermoplastic surface to cause flow can be achieved below the distortion temperature of any of the assembled components.

14. The method according to claim 1 or 2 wherein heating is provided external to the joint region by means selected from the group consisting of electric elements, local provision of heated air or fluid, and induction heating using ferromagnetic particles or electrically conductive material located in or near the joint region to provide heat for joining of the components.

15. The method according to claim 1 or 2 wherein dissimilar thermoplastics that are compatible in welding are selected for surfacing of the composite components.

16. The method according to claim 1 or 2 wherein the thermosetting composite component includes at least one of bearings, bushes, shafts, inserts, foam or honeycomb or other core materials, other thermoplastic polymer subcomponents or films, or any other material that can be incorporated as an integral part of a largely polymer composite component.

17. An apparatus for welding together polymer composite components to form a composite frame, the apparatus including:
a load bearing apparatus;
a plurality of location elements for respectively locating at least one component of the composite frame to be assembled, each location element being connected to the load bearing apparatus;
at least one of said location elements being a moveable location element, the position of said location element being moveable with respect to said load bearing apparatus;
guides for the precise movement of said locating elements to position the composite components into a series of joints which form the composite frame;
at least one actuation means for the at least one moveable location element, the actuation means being attached to the load bearing apparatus and to the at least one moveable location element; and
at least one motion limiting apparatus applied to the at least one moveable location element, the motion limiting apparatus being either a means of control of the force applied by the at least one actuation means, or a mechanical stop.

18. The apparatus according to claim 17 wherein the load bearing apparatus comprises one or more plates or frames, to enable assembly of the composite components into a planar or three-dimensional composite load bearing frame.

19. The apparatus according to claim 18 wherein the guides are mounted to the one or more plates or frames to enable precise relative movement of the location elements.

20. The apparatus according to claim 17 wherein the at least one location element is shaped to securely hold the respective one composite component without interference in the joint area, and apply sufficient force to the at least one composite component to fix its position relative to the location element without damage in subsequent operations.

21. The apparatus according to claim 17 wherein the actuation means is at least one means selected from the group consisting of a motor attached to a screw, gear or other mechanical apparatus for effecting relative motion, a linear motor; a hydraulic apparatus, or a pneumatic apparatus.

22. The apparatus according to claim 17 wherein more than one actuation means act synchronously.

23. The apparatus according to claim 17 further comprising a means to heat the joint region.

24. The apparatus according to claim 23 wherein the heating means is integrated into the location element and is selected from the group consisting of electric means, heated air or fluid and induction heating using ferromagnetic particles or electrically conductive particle located in or near the joint region to provide heat to join the components.

25. The apparatus according to claim 22 further comprising means to cool the joint region.

26. An assembly of at least two polymer composite component wherein the assembly forms a frame and is formed according to the method of claim 1 or 2.

27. The method of fitting polymer composite components of claim 1 or 2 using the apparatus of claim 17.
